(19) United States
(12) Patent Application Publication
(10) Pub. No.: US 2024/0304378 A1
(43) Pub. Date: Sep. 12, 2024

(54) MINIATURE INDUCTIVE COIL AND PREPARATION METHOD THEREOF

(71) Applicant: KUN SHAN MAZO TECH CO., LTD., Suzhou (CN)

(72) Inventors: Jinbing LI, Suzhou (CN); Yitai ZHAO, Suzhou (CN); Jiayan ZHAO, Suzhou (CN); Yongquan LI, Suzhou (CN)

(21) Appl. No.: 18/234,900

(22) Filed: Aug. 17, 2023

Related U.S. Application Data
(63) Continuation of application No. PCT/CN2023/079910, filed on Mar. 6, 2023.

(51) Int. Cl. H01F 27/30; H01F 17/00; H01F 27/32; H01F 41/04

(52) U.S. Cl. CPC H01F 27/306; H01F 17/0013; H01F 27/324; H01F 41/041; H01F 2017/002

(57) ABSTRACT

The present disclosure relates to the technical field of inductive coils, particularly to H01F27/30, and more particularly to a miniature inductive coil and a preparation method thereof. The miniature inductive coil includes: N layers of unclosed ring-shaped planar conductors and coil pins. According to the preparation method of the miniature inductive coil of the present disclosure, the layers of ring-shaped conductors formed by etching are connected through an electroplated conductive via hole embedded in an insulating layer. This avoids the problem of layer-by-layer spanning in traditional coil winding processes, and also avoids damage of varnish coating and breakage of a conductor having a small diameter or sectional area due to excessive tension when the conductor is being wound using winding methods in the prior art.

### CROSS-REFERENCE TO RELATED APPLICATIONS

The present application is a continuation of International Application No. PCT/CN2023/079910, with an international filing date of Mar. 6, 2023, which is based upon and claims priority to Chinese Patent Application No. 202211406882.2, filed on Nov. 10, 2022, the entire contents of all of which are incorporated herein by reference.

### FIELD OF TECHNOLOGY

The present disclosure relates to the technical field of inductive coils, particularly to H01F27/30, and more particularly to a miniature inductive coil and a preparation method thereof.

### BACKGROUND

In a power management system of communication and computing infrastructure, a power module solution is increasingly favored by equipment manufacturers. The power module solution is a technology based on discrete switching power supply, in which device power supply buses are converted into points of load (POLs) in the infrastructure system in a DC/DC way, which greatly reduces the power loss of the circuit. However, this technology puts forward stringent requirements for high density and high integration of the power module, and designers have to give consideration to both high performance and small size when choosing devices.

An inductor is one of the important components of the power module, and its miniaturization of structure size is limited by the design and manufacturing process of coils. The existing inductive coil is made mainly by pulling a conductor by a traction force to move in cooperation with the trajectory of the spindle so as to wind the conductor on the bobbin or magnetic core, thereby forming a multiturn winding. For conductors having a small diameter or sectional area, this winding manner may largely cause damage of varnish coating and breakage of the conductor due to excessive tension when the conductor is being wound. Besides, while the conductor is being wound to form the coil, winding defects inevitably occur due to winding gaps caused by spanning between turns, and moreover, the spanning between turns is also the main reason why the coil design fails to achieve an ideal single-turn coil. For example, Chinese patent CN202122097482 provides an inductive coil mechanism. By arranging socket rings, a plurality of coils are assembled. According to this method, damage of varnish coating and breakage of the conductor may occur due to excessive tension when a single coil conductor is being wound.

### SUMMARY

In view of some problems in the prior art, a first aspect of the present disclosure provides a miniature inductive coil, including:

N layers of unclosed ring-shaped planar conductors, the N layers of unclosed ring-shaped planar conductors being distributed vertically and connected through a conductive hole, and beyond the conductive hole, a physical isolation layer being formed between every two adjacent unclosed ring-shaped planar conductors; N≥2; and
coil pins, including a first coil pin and a second coil pin respectively arranged on the unclosed ring-shaped planar conductor at the bottom and the unclosed ring-shaped planar conductor at the top.

Compared with the coil formed by winding a conductor in the prior art, the miniature inductive coil of this application includes the N layers of unclosed ring-shaped planar conductors, and the N layers of unclosed ring-shaped planar conductors are connected through the conductive hole, which avoids damage of varnish coating and breakage of the conductor having a small diameter or sectional area due to excessive tension when the conductor is being wound using winding methods in the prior art, and also avoids winding defects.

In one embodiment, a material of the physical isolation layer is an insulating material.

In one embodiment, a thickness of the ring-shaped planar conductors is not more than 6 times of a skin depth, preferably not more than 4 times of the skin depth, and more preferably not more than 2 times of the skin depth.

The skin depth is calculated according to the following formula:

$$Δ = \frac{76.2}{\sqrt{f}}$$

where f is the frequency in Hz; and
Δ is the skin depth in mm.

More specifically, when the coil of the present disclosure is applied at a frequency of 300000 Hz or more, the thickness of the ring-shaped planar conductors is not more than 0.56 mm; and preferably, the thickness of the ring-shaped conductors is not more than 0.28 mm. When the coil of the present disclosure is applied at a frequency of 2000000 Hz or more, the thickness of the ring-shaped planar conductors is not more than 0.1 mm; and preferably, the thickness of the ring-shaped conductors is not more than 0.053 mm.

The applicant unexpectedly found that when the thickness of the ring-shaped planar conductors is not more than 4 times of the skin depth, and especially not more than 2 times of the skin depth, the miniature inductive coil of the present disclosure is less affected by the skin effect, and losses of resistance and inductance are lower.

A width of the ring-shaped planar conductors is not particularly limited in this application, and may be routinely selected by those skilled in the art according to their needs, which may be, for example, 250 μm, 300 μm, etc.

In one embodiment, a sectional area A1 of an inner ring of the N layers of ring-shaped planar conductors is not more than a sectional area A2 of a periphery of the ring-shaped planar conductor. Specifically, as shown in FIG. 5, A1 is the grey area in the middle, and A2 is the grey area on the periphery.

The applicant unexpectedly found that when the size of the inner ring of the ring-shaped planar conductors is controlled within the range in this application, the inductor has excellent inductance.

In one embodiment, the conductive hole is arranged in the physical isolation layer, and a number of the conductive holes in each physical isolation layer is greater than or equal to 1, preferably greater than or equal to 2. The specific number may be routinely selected by those skilled in the art. Besides, a diameter of the conductive hole is not particularly limited and may be routinely selected by those skilled in the art.

The conductive hole in the present disclosure is an electrically conductive via hole.

A second aspect of the present disclosure provides a preparation method of the miniature inductive coil, including the following steps:
(1) covering a surface of an insulating material with a layer of a conductor material, performing etching to obtain an unclosed ring-shaped planar conductor and a first coil pin, filling the etched-out part and covering a top of the ring-shaped planar conductor with a layer of the insulating material, performing drilling and electroplating to obtain a physical isolation layer containing a conductive hole, repeating the above operations to obtain N layers of unclosed ring-shaped planar conductors, etching the last layer of the ring-shaped planar conductor to obtain a second coil pin, and covering an upper surface of the etched and filled conductor with the insulating material; and
(2) retaining a certain thickness of an insulating film, and removing the excess insulating material outside and inside the ring-shaped planar conductors by laser cutting.

In one embodiment, the preparation method of the miniature inductive coil includes the following steps:
(1) covering a surface of an insulating material with a layer of a conductor material, etching the conductor material to obtain an unclosed ring-shaped planar conductor, performing etching to obtain a first coil pin, the etched-out part of the conductor is filled with an insulating material, covering a surface of the conductor with a layer of the insulating material, and performing drilling and electroplating on the insulating material to form a conductive hole running through the insulating layer;
(2) covering a surface of the insulating material embedded with the conductive hole with a layer of the conductor material, etching the conductor material to form an unclosed ring-shaped planar conductor, and filling the etched-out part of the conductor with the insulating material; covering an upper surface of the etched and filled conductor with the insulating material, and performing drilling and electroplating on the insulating material to form a conductive hole running through the insulating layer; repeating step (2) to obtain N layers of unclosed ring-shaped planar conductors covered with the insulating material;
(3) covering a surface of the topmost layer of the insulating material in step (2) with a layer of the conductor material, etching the conductor material to form an unclosed ring-shaped planar conductor and a second coil pin, and filling the etched-out part of the conductor with the insulating material; covering an upper surface of the etched and filled conductor with the insulating material; and
(4) retaining a certain thickness of an insulating film, and removing the excess insulating material outside and inside the ring-shaped planar conductors by laser cutting.

In one embodiment, the insulating material is selected from any one or more of polyimide, polyamide and epoxy resin.

The conductor material in this application is a metal material, preferably copper.

The thickness of the insulating film in this application is not particularly limited, which may be, for example, 20 μm, 25 μm, 30 μm, etc.

Compared with the prior art, the present disclosure has the following beneficial effects:

According to the preparation method of the miniature inductive coil of the present disclosure, the layers of ring-shaped conductors formed by etching are connected through the electroplated conductive via hole embedded in the insulating layer. This avoids the problem of layer-by-layer spanning in traditional coil winding processes, and also avoids damage of varnish coating and breakage of the conductor having a small diameter or sectional area due to excessive tension when the conductor is being wound using winding methods in the prior art.

### BRIEF DESCRIPTION OF THE DRAWINGS

FIG. 1 is a diagram showing a preparation flow of a miniature inductive coil;

FIG. 2 is a schematic structural view of the miniature inductive coil; 1—first coil pin, 2—second coil pin, 3—ring-shaped planar conductor;

FIG. 3 is a chart of alternating-current resistance testing of Example 1 and Comparative Example 1;

FIG. 4 is a top perspective view of the miniature inductive coil of Example 1; and

FIG. 5 is a schematic view showing an area of an inner ring of the miniature inductive coil.

### DESCRIPTION OF THE EMBODIMENTS

The present disclosure will be described below by way of specific embodiments, but is not limited to the specific examples given below.

### Example 1

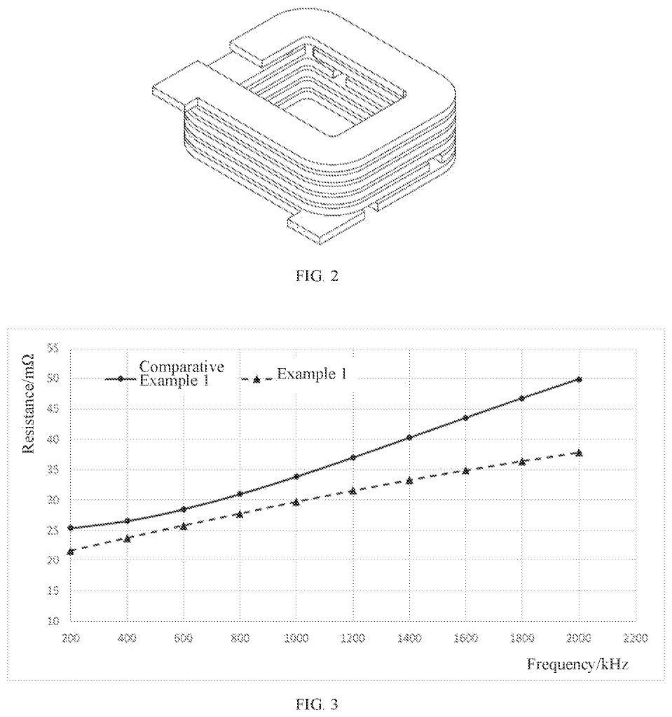

A miniature inductive coil, as shown in FIG. 2, includes: 6 layers of unclosed ring-shaped planar conductors 3 and coil pins. The 6 layers of unclosed ring-shaped planar conductors 3 are distributed vertically and connected through a conductive hole, and beyond the conductive hole, a physical isolation layer is formed between every two adjacent unclosed ring-shaped planar conductors by means of an epoxy resin layer. The ring-shaped planar conductors have a thickness of 48.5 μm and a width of 250 μm.

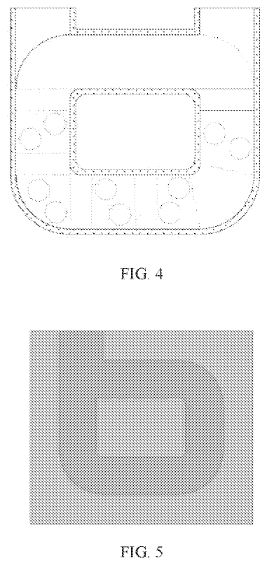

The coil pins include a first coil pin 1 and a second coil pin 2 respectively arranged on the unclosed ring-shaped planar conductor at the bottom and the unclosed ring-shaped planar conductor at the top. A top perspective view of the obtained miniature inductive coil is shown in FIG. 4.

A preparation method of the miniature inductive coil includes:

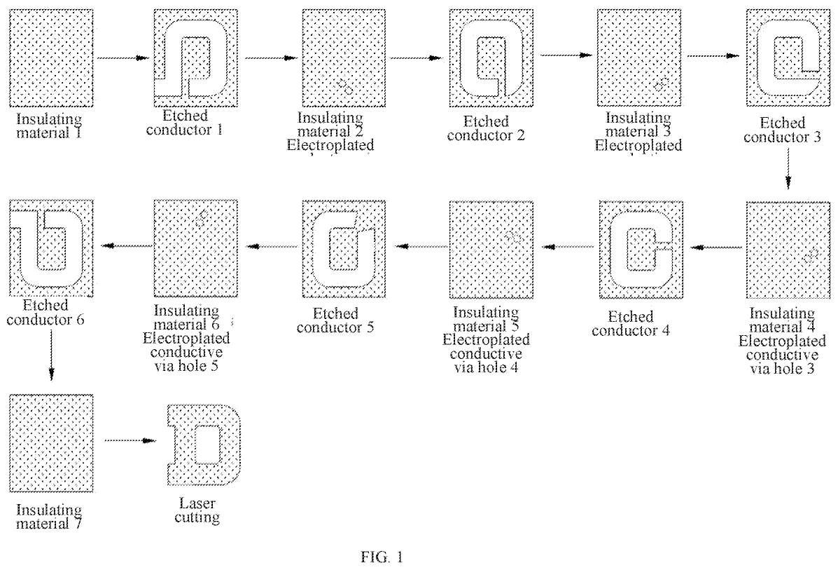

A copper sheet covering a surface of a polyimide material having a size of 1400 μm*1200 μm*25 μm is etched to obtain 6 layers of unclosed ring-shaped planar conductors covered with epoxy resin. The adjacent conductors are connected through two electroplated conductive via holes having a diameter of 100 μm. The ring-shaped conductors have a thickness of 48.5 μm and a width of 250 μm. An inner ring of the ring-shaped conductors has a size of 450 μm*650 μm. The first coil pin is connected to an unclosed end of the ring-shaped planar conductor at the bottom, and the second coil pin is connected to an unclosed end of the ring-shaped planar conductor at the top. The excess polyimide material on the surface of the conductors is removed by laser cutting, and a thickness of insulation of 25 μm is retained. The specific flow diagram is shown in FIG. 1.

The coil is encapsulated in a magnetic material having a size of 1400*1200*1000. A relative permeability of the magnetic material is 30, and a sectional area Ae of the magnetic core of the inductor is 0.2925 mm².

### Example 2

A miniature inductive coil of this example is the same as in Example 1, except that the ring-shaped planar conductors have a thickness of 60 μm.

A preparation method of the miniature inductive coil is the same as in Example 1.

The coil is encapsulated in a magnetic material having a size of 1400*1200*1000. A relative permeability of the magnetic material is 30, and a sectional area Ae of the magnetic core of the inductor is 0.2925 mm².

### Example 3

A miniature inductive coil of this example is the same as in Example 1, except that the ring-shaped planar conductors have a thickness of 25 μm.

A preparation method of the miniature inductive coil is the same as in Example 1.

The coil is encapsulated in a magnetic material having a size of 1400*1200*1000. A relative permeability of the magnetic material is 30, and a sectional area Ae of the magnetic core of the inductor is 0.2925 mm².

### Example 4

A miniature inductive coil and a preparation method thereof of this example are the same as in Example 1.

The coil is encapsulated in a magnetic material having a size of 1400*1200*1000. A relative permeability of the magnetic material is 30, and a sectional area Ae of the magnetic core of the inductor is 0.5525 mm².

### Example 5

A miniature inductive coil and a preparation method thereof of this example are the same as in Example 1.

The coil is encapsulated in a magnetic material having a size of 1400*1200*1000. A relative permeability of the magnetic material is 30, and a sectional area Ae of the magnetic core of the inductor is 0.6825 mm².

Examples 1 to 5 were tested for their characteristics of inductors. The results are shown in Table 1.

TABLE 1

| | Example 1 | | Example 2 | | Example 3 | | Example 4 | | Example 5 | |
|---|---|---|---|---|---|---|---|---|---|---|
| Freq | Resis- | Induc- | Resis- | Induc- | Resis- | Induc- | Resis- | Induc- | Resis- | Induc- |
| [MHz] | tance/mΩ | tance/nH | tance/mΩ | tance/nH | tance/mΩ | tance/nH | tance/mΩ | tance/nH | tance/mΩ | tance/nH |
| 0.2 | 21.6 | 268.1 | 17.6 | 236.9 | 40.8 | 347.0 | 21.9 | 308.8 | 24.3 | 303.1 |
| 0.4 | 23.7 | 267.4 | 19.4 | 236.4 | 44.5 | 346.0 | 23.4 | 308.4 | 26.6 | 302.5 |
| 0.6 | 25.8 | 267.0 | 21.2 | 236.0 | 48.1 | 345.2 | 25.2 | 308.1 | 29.0 | 302.1 |
| 0.8 | 27.7 | 266.7 | 22.9 | 235.7 | 51.4 | 344.6 | 27.3 | 307.9 | 31.6 | 301.7 |
| 1 | 29.6 | 266.4 | 24.7 | 235.5 | 54.6 | 344.2 | 29.4 | 307.7 | 34.2 | 301.4 |
| 1.2 | 31.5 | 266.2 | 26.4 | 235.4 | 57.6 | 343.8 | 31.5 | 307.5 | 36.9 | 301.2 |
| 1.4 | 33.2 | 266.0 | 28.0 | 235.2 | 60.4 | 343.5 | 33.5 | 307.3 | 39.4 | 301.0 |
| 1.6 | 34.8 | 265.9 | 29.6 | 235.1 | 62.9 | 343.3 | 35.5 | 307.2 | 41.8 | 300.8 |
| 1.8 | 36.4 | 265.8 | 31.1 | 235.0 | 65.3 | 343.0 | 37.3 | 307.0 | 44.0 | 300.6 |
| 2 | 37.8 | 265.7 | 32.6 | 234.9 | 67.5 | 342.9 | 39.1 | 306.9 | 46.1 | 300.4 |

As can be seen from the results of Example 1 to Example 3, the larger the thickness of the ring-shaped conductors, the lower the inductance and the resistance of the inductor. Moreover, as can be seen from the test results of Example 1 to Example 5, an increase in the size of the inner ring of the ring-shaped conductors, i.e., the sectional area Ae of the magnetic core, leads to an increase in the inductance of the inductor. After the size of the inner ring of the ring-shaped conductors increases to a certain value, the inductance of the inductor decreases.

### Comparative Example 1

A copper wire was wound on a rectangular bobbin having a size of 450 μm*650 μm. The number of turns was 6, 3 turns as the inner layer and 3 turns as the outer layer. The copper wire had a diameter of 120 μm, and was coated with a varnish film having a thickness of 25 μm. The first coil pin was formed by winding the inner layer of the coil inward, and the second coil pin was formed by winding the outer layer of the coil outward.

Example 1 and Comparative Example 1 were tested for their alternating-current resistance. The test results are shown in FIG. 3. As can be seen from FIG. 3, the resistance of the conductors in Example 1 of the present disclosure varies with the current with a smaller amplitude, because the conductors prepared according to the present disclosure have a smaller size, and thus are less affected by the skin depth than the coil prepared by the traditional winding manner. This helps in ensuring a lower alternating-current loss when the inductor is at a high frequency.

What is claimed is:

1. A miniature inductive coil, comprising:
N layers of unclosed ring-shaped planar conductors, the N layers of unclosed ring-shaped planar conductors being distributed vertically and connected through a conductive hole, and beyond the conductive hole, a physical isolation layer being formed between every two adjacent unclosed ring-shaped planar conductors, wherein N≥2; and
coil pins, comprising a first coil pin and a second coil pin respectively arranged on the unclosed ring-shaped planar conductor at the bottom and the unclosed ring-shaped planar conductor at the top.

2. The miniature inductive coil of claim 1, wherein a material of the physical isolation layer is an insulating material.

3. The miniature inductive coil of claim 2, wherein the insulating material is selected from one or more of polyimide, polyamide and epoxy resin.

4. The miniature inductive coil of claim 1, wherein the ring-shaped planar conductors have a thickness of no more than 6 times of a skin depth.

5. The miniature inductive coil of claim 4, wherein the thickness of the ring-shaped planar conductors is not more than 4 times of the skin depth, preferably not more than 2 times of the skin depth.

6. The miniature inductive coil of claim 4, wherein the skin depth is calculated according to the following formula:
$$Δ = \frac{76.2}{\sqrt{f}} ,$$
wherein f is me frequency in Hz, and Δ is the skin depth in mm.

7. The miniature inductive coil of claim 6, wherein a sectional area A1 of an inner ring of the N layers of ring-shaped planar conductors is not more than the sectional area A2 of a periphery of the ring-shaped planar conductor.

8. The miniature inductive coil of claim 7, wherein the conductive hole is arranged in the physical isolation layer, and the conductive holes in each physical isolation layer have a number greater than or equal to 1, preferably greater than or equal to 2.

9. A preparation method of the miniature inductive coil of claim 1, comprising the following steps:
(1) covering a surface of an insulating material with a layer of a conductor material, performing etching to obtain an unclosed ring-shaped planar conductor and a first coil pin, filling the etched-out part and covering a top of the ring-shaped planar conductor with a layer of the insulating material, performing drilling and electroplating to obtain a physical isolation layer containing a conductive hole, repeating the above operations to obtain N layers of unclosed ring-shaped planar conductors, etching the last layer of the ring-shaped planar conductor to obtain a second coil pin, and covering an upper surface of the etched and filled conductor with the insulating material; and
(2) retaining a certain thickness of an insulating film, and removing the excess insulating material outside and inside the ring-shaped planar conductors by laser cutting.
